(19) United States
(12) Patent Application Publication
(10) Pub. No.: US 2015/0273325 A1
(43) Pub. Date: Oct. 1, 2015

(54) Adaptable Handle for Tactile Tablet

(71) Applicant: Bigben Interactive SA, Lesquin (FR)

(72) Inventors: Alain Falc, Kortrijk (BE); Yannick Allaert, Meurchin (FR); Sébastien Moreau, Bassee (FR)

(73) Assignee: Bigben Interactive SA, Lesquin (FR)

(21) Appl. No.: 14/669,132

(22) Filed: Mar. 26, 2015

(30) Foreign Application Priority Data
Mar. 27, 2014 (FR) 14 52675

(51) Int. Cl. A63F 13/24; A63F 13/98

(52) U.S. Cl. CPC A63F 13/24; A63F 13/98

(57) ABSTRACT

An adaptable handle arranged to receive a tactile tablet includes two side portions, a width setting unit arranged to adjust a width between the two side holding portions and to allow the handle to receive one of at least two tactile tablets of different sizes. The width setting unit includes a first adjustment unit arranged to enable a first width setting of the two side portions by successive incremental values of width, and a second adjustment unit arranged between the two side portions and in series with the first adjustment unit, to enable a second additional width setting of the two side portions in a continuous range of values, and an elastic return unit.

This application claims priority to French patent application No. 14 52675 filed on Mar. 27, 2014, the entire contents of which are incorporated herein by reference.

### BACKGROUND

The present invention generally concerns an adaptable handle, or game pad arranged to receive a tactile tablet, and offer to the user a man-machine interface adapted to the practice of video games for example.

### SUMMARY

Handles or game pads arranged to receive tactile tablets are known in the prior art. Because of the diversity of tactile tablets, with a multitude of different sizes or formats, it is interesting to propose a handle which can adapt to different sizes of tactile tablets. However, the width adjustment unit is generally limited and the known handles are often dedicated to a restricted range of tablets. In addition, the width adjustment can be tedious with locks between the side portions of the handle, without limiting the risk of detachment between the handle and the tactile tablet, resulting in a drop or fall of the tactile tablet.

CN201283220Y discloses an expandable handle for a portable electronic apparatus.

An aim of the present invention is to address the aforementioned drawbacks of the prior art and particularly, first of all, to propose an adaptable handle for receiving a tactile tablet among at least two tactile tablets of different sizes, with a simple and secured width setting.

For this, a first aspect of the invention concerns an adaptable handle arranged to receive a tactile tablet and comprising:

two side holding portions for the tactile tablet,

a width setting unit arranged between the two side holding portions to adjust a width between the two side holding portions and to allow to receive one among at least two tactile tablets of different sizes, wherein the width setting unit comprises:

a first adjustment unit arranged between the two side portions to enable a first width setting of the two side portions by successive incremental values of width, and comprising first locking unit arranged to lock the first adjustment unit in an incremental width setting position,

a second adjustment unit arranged between the two side portions to enable a second additional width setting of the two side portions in a continuous range of values, and comprising elastic return unit arranged to exert a return force or back force toward the first width setting.

The adaptable handle (or game pad or holder) according to the present implementation offers two distinct adjustment units. The first adjustment unit offers a first quick width setting by incremental values to perform an approximate adjustment of the width, and a blocking or locking in this position. Then, the second adjustment unit allows to perform the final and exact width setting (in a continuous range of values) to perfectly adapt to the size of the tactile tablet to be received. The elastic return unit toward the first width setting finally allows to effectively pinch or clamp the tactile tablet once the latter is installed in the adaptable handle, which limits the risks of detachment. In summary, the user has simply to perform a first quick width setting, block the first adjustment unit and then install the tactile tablet by controlling the second width setting unit, and the elastic return unit is responsible for automatically bringing closer or retract the two side portions to pinch or clamp the tactile tablet.

It is to be noted that the reference “tactile tablet” is not limitative of the usage of the handle according to the present invention, which can also serve to receive a touch screen mobile phone, otherwise called smart phone. It is furthermore difficult to distinguish between a tactile tablet and a mobile phone, particularly in the case of a portable electronic apparatus (even if it is called tablet), equipped with a touch screen and with a 3G wireless communication module for example, such that the handle is usable with any portable electronic apparatus equipped with a touch screen.

Advantageously, the second adjustment unit is arranged in series with the first adjustment unit.

Advantageously, the adaptable handle comprises a contact interface arranged to be in contact with the tactile tablet received by the handle, and the contact interface comprises a non-slip material. The non-slip material limits the relative movements between the adaptable handle and the tactile tablet in synergy with the elastic return unit, as the latter increases the frictional force by creating a contact force between the tactile tablet and the non-slip material.

Advantageously, the non-slip material is an elastomer. For example EPDM (ethylene-propylene-diene monomer) or rubber can be considered.

Advantageously, the second adjustment unit is arranged to enable the second width setting within a width interval inferior or smaller to four successive incremental values of width. The width adjustment range with the second width setting unit is advantageously limited not to impact the overall size, but allows, by covering several incremental adjustment values, to adapt to all tactile tablets.

Advantageously, the second adjustment unit comprises a second locking unit arranged to lock the second adjustment unit in a width setting position adapted to the tactile tablet received by the handle.

Advantageously, the first adjustment unit is a rack slide.

Advantageously, the second adjustment unit is a slide, and the elastic return unit is a spring.

Advantageously, the adaptable handle comprises:

a communication unit with the tactile tablet arranged to send and/or receive signals to the tactile tablet,

a control unit connected to the communication unit and arranged to generate control signals for the tactile tablet. The handle according to this implementation is furthermore able to generate and send electric control signals to the tactile tablet.

Advantageously, the control unit comprises at least one man-machine interface with control buttons.

Advantageously, the adaptable handle comprises a tactile information unit connected to the communication unit and arranged to receive a tactile signal control sent from the tactile tablet. As their name indicates, the tactile information unit is arranged to appeal to the sense of touch of the user, that is to say that one can vary the shape of the handle (a portion of the handle is deformable), the temperature of the handle (a portion of the handle can generate cold or heat), or even generate vibrations, for example.

Advantageously, the tactile information unit comprises at least one vibrator arranged to vibrate at least one portion of the adaptable handle.

Advantageously, the adaptable handle comprises a holding unit arranged to hold in place the tactile tablet when it is received by the adaptable handle. A lock which adapts to a fixing interface of the tactile tablet can be considered, or a retractable leg between a retracted position in which the tactile tablet can be inserted or removed from the adaptable handle, and a locking position in which any removal movement of tactile tablet is impossible.

Other features and advantages of the present invention will become clearly apparent when reading the following detailed description of an embodiment of the invention given by way of non-limiting example and illustrated by the accompanying drawings, in which:

### BRIEF DESCRIPTION OF THE DRAWINGS

FIG. 1 shows an isometric front view of an adaptable handle according to the present invention.

FIG. 2 shows a rear view of the adaptable handle of FIG. 1.

FIG. 3 shows a view of the adaptable handle of FIG. 1 being engaged with a tactile tablet.

FIG. 4 shows the adaptable handle of FIG. 1 with a tactile tablet.

### DETAILED DESCRIPTION

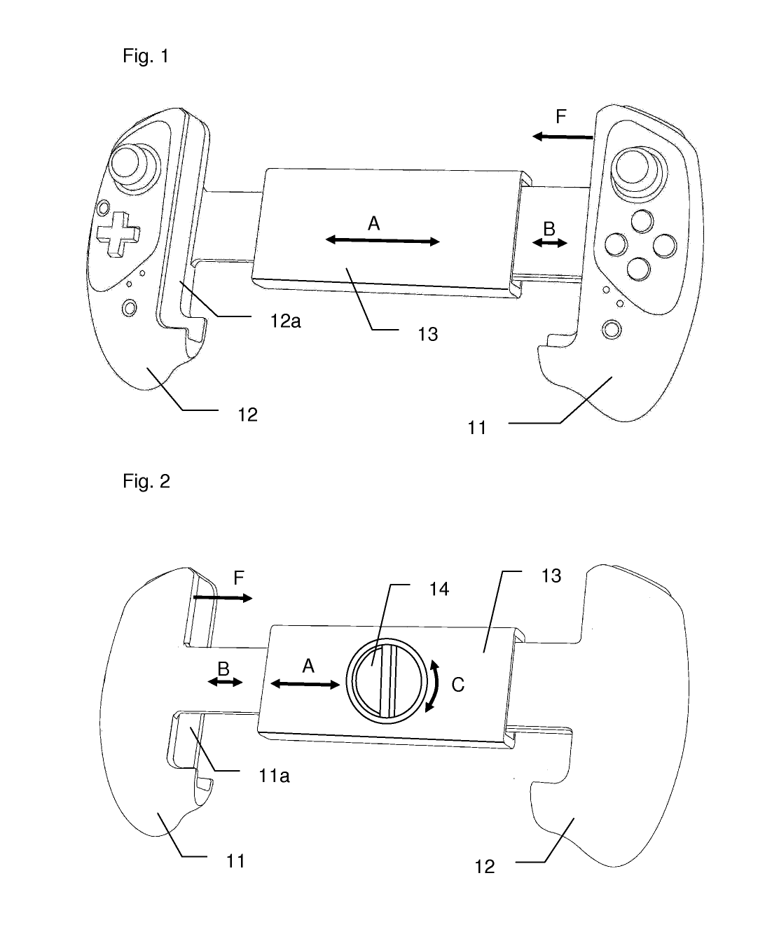

Turning to FIG. 1, it shows an isometric view of an adaptable handle according to the present invention which comprises two side portions 11 and 12 connected together by an arm comprising a slider 13.

The adaptable handle of FIG. 1 can receive a tactile tablet 20 and the side portions 11 and 12 comprise control buttons to form man-machine interfaces in order to easily play a game with the tactile tablet 20 when it is received and/or engaged with the adaptable handle.

The connection between the adaptable handle and the tactile tablet 20 can be carried out in different ways, and a wired connection via a USB or micro USB type plug of the tactile tablet 20 can be cited, for example, or even wireless connections according to different protocols such as Wi-Fi or Bluetooth, for example.

In order to properly engage with the tactile tablet 20, each side portion 11 and 12 comprises a groove, with only the groove 12a of the side portion 12 being visible on this figure. The groove 11a of the side portion 11 is visible in FIG. 2.

In addition, in order to be able to propose an adaptable handle to the different tactile tablets on the market, the adaptable handle according to the present invention can adapt to at least two tactile tablets of different sizes. To this end, the adaptable handle comprises a first width setting unit that allows the slider 13 and the side portion 11 to be in movement relative to the side portion 12 according to the movement A.

The adaptable handle also comprises second width setting unit which allows the side portion 11 to be in movement relative to the slider 13 according to the movement B. The movement A and the movement B are sliding movements.

The movement A therefore enables a first quick width setting according to predetermined length increments, as enabled by an engagement in slots for example. Once this first width setting performed, a blocking or locking of the slider 13 relative to the side portion 12 is performed. Then, the movement B enables an additional width setting, but in a continuous range of values, to offer a perfect adaptation to the width of the tactile tablet 20 in question.

In order to secure the holding in place of the tactile tablet 20, an elastic force F is continuously exerted on the side portion 11 to bring it closer to the other side portion 12. Thus, the tactile tablet 20 will be sandwiched between the two side portions 11 and 12. Connecting the side portion 11 to the slider 13 by a tension spring for example can be in particular considered.

Implanting for example at the bottom of the groove 12a and/or 11a a non-slip material such as an elastomer, a rubber or another material, can be considered, which will prevent any slippage of the tactile tablet 20 relative to the adaptable handle.

FIG. 2 shows a rear view of the adaptable handle of FIG. 1, where a locking unit of movement A is shown and which consists of a knob 14 that can pivot according to a movement C to lock or unlock the movement A of the slider 13 relative to the side portion 12. It is to be noted that the movement B of the side portion 11 relative to the slider 13 is always possible.

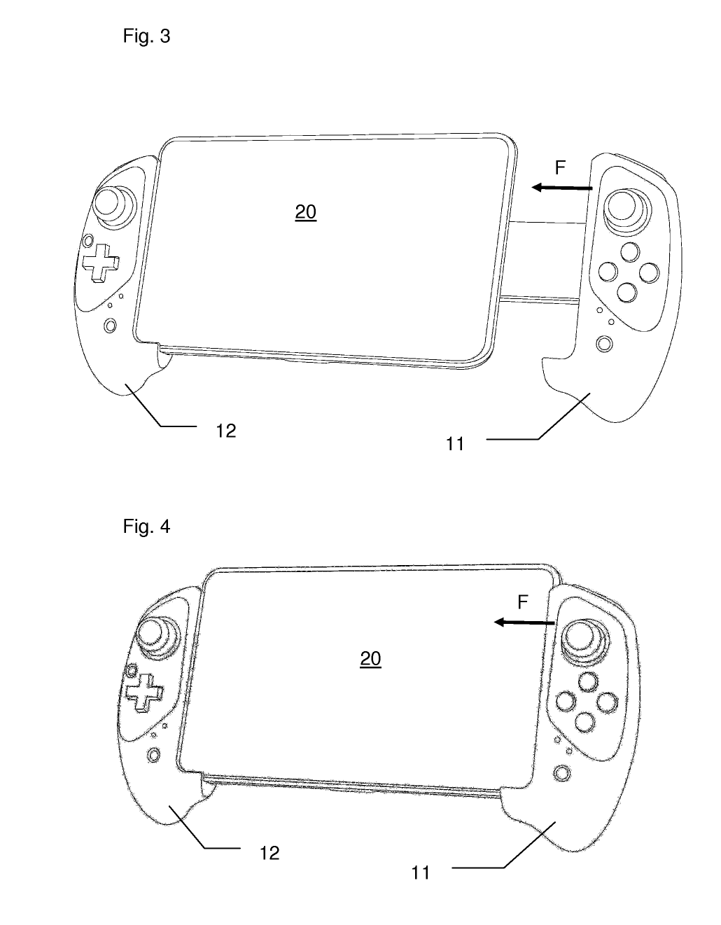

FIG. 3 shows the engagement of a tactile tablet 20 with the adaptable handle. The first adjustment according to the movement A allowed to bring the side portion 11 slightly recessed relative to the width of the tactile tablet 20 shown and the user must block in position the slider 13 (not visible here as hidden by the tactile tablet 20), and then pull on the side portion 11 to move it away again, despite the return force F shown.

FIG. 4 shows the tactile tablet 20 engaged on the adaptable handle, with the side portion 11 in contact with the tactile tablet 20, and which exerts a force F, which ensures a good holding in place.

It will be understood that various modifications and/or improvements evident to those skilled in the art can be brought to the different embodiments of the invention described in the present description without departing from the scope of the invention defined by the accompanying claims.

Particularly, no size limitation is retained in the claims, and the destination of use to accommodate a mentioned tactile tablet cannot be interpreted as limiting the size of the handle. Particularly, small sized tactile tablets can be smaller than big sized mobile phones

1. An adaptable handle arranged to receive a portable electronic apparatus equipped with a touch screen, comprising:
two side portions for holding the portable electronic apparatus,
a width setting unit arranged between the two side holding portions to adjust a width between the two side holding portions and to receive one of at least two portable electronic apparatuses of different sizes, wherein the width setting unit comprises:
a first adjustment unit arranged between the two side portions to enable a first width setting of the two side portions by successive incremental values of width, and comprising a first locking unit arranged to lock the first adjustment unit in an incremental width setting position, and
a second adjustment unit arranged between the two side portions to enable a second additional width setting of the two side portions in a continuous range of values, and comprising an elastic return unit arranged to exert a back force toward the first width setting.

2. The adaptable handle according to claim 1, wherein the portable electronic apparatus is a tactile tablet.

3. The adaptable handle according to claim 1, comprising a contact interface arranged to be in contact with the tactile tablet received by the handle, and wherein the contact interface comprises a non-slip material.

4. The adaptable handle according to claim 1, wherein the non-slip material is an elastomer.

5. The adaptable handle according to claim 1, wherein the second adjustment unit is arranged to enable the second width setting within a width interval smaller than four successive incremental values of width.

6. The adaptable handle according to claim 1, wherein the second adjustment unit comprises a second locking unit arranged to lock the second adjustment unit in a width setting position adapted to the tactile tablet received by the handle.

7. The adaptable handle according to claim 1, wherein the first adjustment unit is a rack slide.

8. The adaptable handle according to claim 1, wherein the second adjustment unit is a slide and the elastic return unit is a spring.

9. The adaptable handle according to claim 1 further comprising:
a communication unit with the tactile tablet arranged to send and/or receive signals to the tactile tablet; and
a control unit connected to the communication unit and arranged to generate control signals for the tactile tablet.

10. The adaptable handle according to claim 1, wherein the control unit comprises at least one man-machine interface with control buttons.

11. The adaptable handle according to claim 8, comprising a tactile information unit connected to the communication unit and arranged to receive a tactile signal control sent from the tactile tablet.

12. The adaptable handle according to claim 11, wherein the tactile information unit comprises at least one vibrator arranged to vibrate at least one portion of the adaptable handle.

13. The adaptable handle according to claim 1, comprising a holding unit arranged to hold in place the tactile tablet when it is received by the adaptable handle.
